(19) United States
(12) Patent Application Publication
(10) Pub. No.: US 2014/0369861 A1
(43) Pub. Date: Dec. 18, 2014

(54) JET PUMP UNIT

(71) Applicant: Hyundai Motor Company, Seoul (KR)

(72) Inventors: Yong Gyu Noh, Suwon (KR); Sekwon Jung, Seongnam (KR)

(73) Assignee: HYUNDAI MOTOR COMPANY, Seoul (KR)

(21) Appl. No.: 14/143,380

(22) Filed: Dec. 30, 2013

(30) Foreign Application Priority Data
Jun. 12, 2013 (KR) 10-2013-0067350

(51) Int. Cl. H01M 8/04; F04F 5/46; F04F 5/54

(52) U.S. Cl. CPC H01M 8/04089; F04F 5/54; F04F 5/463
USPC 417/194

(57) ABSTRACT

A jet pump unit, including: a nozzle housing having a vacuum chamber formed therein and connected with a recirculation line; a jet nozzle in which a front end is placed in the vacuum chamber of the nozzle housing, a nozzle aperture injecting fluid to the outside is formed on the front end, a slanted surface is formed on an exterior with an outer diameter gradually decreasing toward the nozzle aperture, and a concave notch is concave toward a rear end of the nozzle aperture; and a mixture pipe in which the fluid injected from the nozzle aperture of the jet nozzle and recirculation fluid that is sucked into the vacuum chamber are mixed.

### CROSS-REFERENCE TO RELATED APPLICATION

This application claims priority to and the benefit of Korean Patent Application No. 10-2013-0067350 filed in the Korean Intellectual Property Office on Jun. 12, 2013, the entire contents of which are incorporated herein by reference.

### BACKGROUND

(a) Field of the Invention

The present invention relates to a jet pump unit that sucks recirculation fluid through formation of vacuum by fuel fluid injected through an injection aperture of a jet nozzle and uniformly mixes the suctioned recirculation fluid and the injected fuel fluid.

(b) Description of the Related Art

A jet pump can serve to circulate a fluid by injecting compressed fluid (such as gas or liquid) through a nozzle, and forming vacuum by the injected fluid or via pumping pressure. Conventional jet pumps, however, do not have substantially high in efficiency, even though they have a fairly simple structure. Additionally, they often malfunction, but require only minimal maintenance. Regardless, jet pumps can smoothly perform a function at low cost in a system exposed to a severe environment.

However, when the amount of the fluid supplied through the nozzle of the jet pump is small, suction (pumping) pressure cannot be normally maintained for a long period of time. As such, the performance of the jet pump can be improved by pulse-control via a valve.

As such, on and off functions for the valve should be repeated at a cycle of at least 10 to 60 Hz in order to form a pulse flow under a low-load operating condition, and as a result, the valve may be abraded or noise may be generated. In these types of pumps, the nozzle needs to be small in order to minimize the pulse flowing, but required fuel fluid (hydrogen) cannot be stably pumped under a maximum output conditions. As such, a jet pump that is more appropriated for these output conditions and that is more efficient is required.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a jet pump unit that can stably inject fuel fluid at a low output and a high output by enhancing the structure of a jet nozzle and promote mixing fuel fluid and recirculation fluid by maximizing turbulence and swirl effects.

An exemplary embodiment of the present invention provides a jet pump unit is provided. This jet pump unit may include a nozzle housing having a vacuum chamber formed therein and connected with a recirculation line; a jet nozzle in which a front end is placed in the vacuum chamber of the nozzle housing, a nozzle aperture injecting fluid to the outside is formed on the front end, a slanted surface is formed on an exterior with an outer diameter gradually decreasing toward the nozzle aperture, and a concave notch is concave toward a rear end of the nozzle aperture; and a mixture pipe in which the fluid injected from the nozzle aperture of the jet nozzle and recirculation fluid that is sucked into the vacuum chamber are mixed.

The jet pump unit may further include a virtual first vertical line crossing vertically to the central axis on the front end of the nozzle aperture of the jet nozzle, and the concave notch may be formed by an outer notch surface including the first vertical line and having a first acute angle to the central axis. The outer notch surface may be symmetrically formed at both sides based on the central axis of the jet nozzle.

A virtual second vertical line may also be formed, which is parallel to the virtual first vertical line that crosses vertically to the central axis on the front end of the nozzle aperture of the jet nozzle, and which is spaced from the first vertical line by a first distance d1 which is set in a rearward direction, crosses vertically to the central axis, and is parallel to the first vertical line, and the concave notch may be formed by the inner notch surface including the second vertical line and having a second acute angle to the central axis. As such, the inner notch surface may be symmetrically formed at both sides based on the central axis of the jet nozzle.

Also an intermediate portion having a small inner diameter in the mixture pipe may be formed by a wrinkle pipe.

In some exemplary embodiments, the shielding member may be placed on an exterior of the mixture pipe. The shielding member may include a sound absorption material or an insulation material.

A supply path connected with the injection aperture and having an inner diameter set on a length-direction central axis may be formed in the jet nozzle. The set inner diameter may gradually decrease toward the nozzle aperture of the jet nozzle.

According to an exemplary embodiment of the present invention, swirl instability of fluid injected at a high velocity is increased by processing an injection aperture of a jet nozzle in a notch shape to stably mix fuel fluid and recirculation fluid. Further, a wrinkle pipe is applied to a mixture part of a jet pump to induce generation of turbulence and improve assemblability.

### BRIEF DESCRIPTION OF THE DRAWINGS

FIG. 1 is an overall cross-sectional view of a jet pump unit according to an exemplary embodiment of the present invention.

FIG. 2 is a partial perspective view of a jet nozzle provided in a jet pump unit according to a first exemplary embodiment of the present invention.

FIG. 3 is first and second side views of a jet nozzle according to the first exemplary embodiment of the present invention.

FIG. 4 is a partial perspective view of a jet nozzle provided in a jet pump unit according to a second exemplary embodiment of the present invention.

FIG. 5 is first and second side views of the jet nozzle according to the second exemplary embodiment of the present invention.

FIG. 6 is an overall cross-sectional view of a jet pump unit according to a third exemplary embodiment of the present invention.

### DETAILED DESCRIPTION OF THE EMBODIMENTS

An exemplary embodiment of the present invention will hereinafter be described in detail with reference to the accompanying drawings.

It is understood that the e term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum). Thus, although the present invention is directed toward the inventions use in a fuel cell vehicle, the invention's use is not limited thereto.

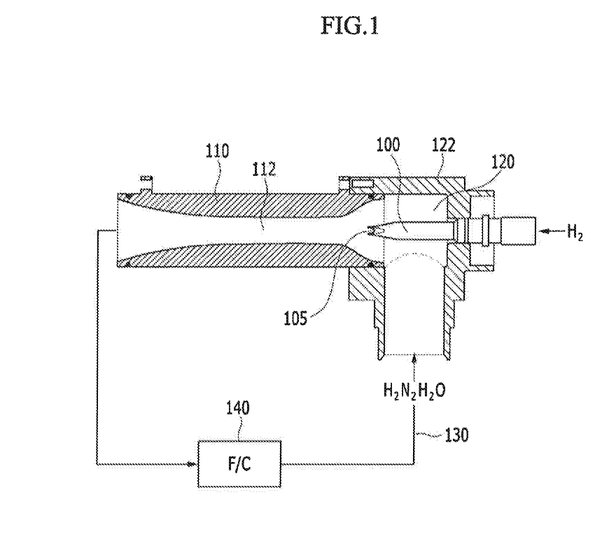

FIG. 1 is an overall cross-sectional view of a jet pump unit according to an exemplary embodiment of the present invention. Referring to FIG. 1, a fuel cell allows hydrogen circulated through a recirculation line and separately supplied to react to each other to generate electricity. A fuel cell system including the fuel cell includes a recirculation line 130, a nozzle housing 122, a jet nozzle 100, and a mixture pipe 110. A vacuum chamber 120 sucks fluid including hydrogen, nitrogen, and water discharged from the fuel cell 140 from the bottom and is formed in the nozzle housing 122.

The jet nozzle 100 is inserted into the nozzle housing 122 and a nozzle aperture 105 injecting hydrogen is formed on a front end of the jet nozzle 100. Herein, when the jet nozzle 100 injects hydrogen through the nozzle aperture 105 at high speed, the pressure of the vacuum chamber 120 decreases to suck fluid including hydrogen, nitrogen, and water through the recirculation line 130.

The mixture pipe 110 is placed at a front portion of the jet nozzle 100 and a mixture space 112 in which hydrogen and fluid injected from the jet nozzle 100 are mixed is formed in the mixture pipe 110. The mixture space 112 has a structure in which the inner diameter decreases toward the intermediate portion at one side, and the inner diameter is smallest at an intermediate portion. The inner diameter also increases at the other side at the intermediate portion again. The hydrogen injected from the jet nozzle and the recirculation fluid which is recirculated is uniformly mixed while passing through the mixture space 112 of the mixture pipe 110.

In the exemplary embodiment of the present invention, the structure of the nozzle aperture 105 is enhanced in the jet nozzle 100 to improve pumping and mixing performance of the jet nozzle 100. That is, fluid is sucked by forming vacuum pressure formed by hydrogen injected from the nozzle aperture 105 of the jet nozzle 100 and forming vacuum through motion energy of the injection fluid and when the amount of the fluid injected from the jet nozzle 100 is small, overall flow rate and pumping pressure decrease.

Therefore, when the amount of the fluid injected from the jet nozzle 100 is small, the diameter of the nozzle aperture 105 is decreased in order to acquire required pumping pressure and in this state, effective mixing is required in the mixture space 112 and it is important to effectively transfer the motion energy of the injection fluid.

In the exemplary embodiment of the present invention, the jet nozzle 100 allows injection fluid (a raw material, for example, hydrogen) injected from the mixture pipe 110 and the suction fluid (the recirculation fluid, for example, hydrogen, water, and nitrogen) are uniformly mixed by using strong turbulence and swirl generated by unsteady flow.

Therefore, the jet nozzle 100 may decrease an on/off actuation region of the valve under a low-load operating condition of the fuel cell 140 by enhancing efficiency of the jet pump and improves suction efficiency when the fuel fluid is injected from the jet nozzle 100 in a pulse type.

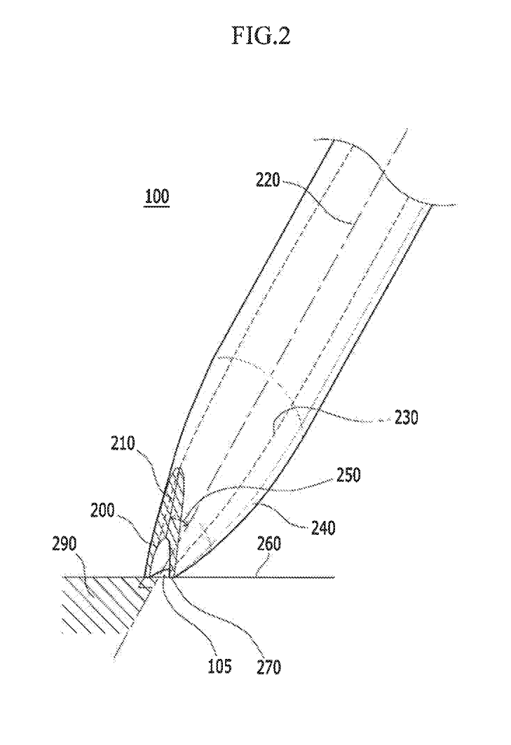

FIG. 2 is a partial perspective view of a jet nozzle provided in a jet pump unit according to a first exemplary embodiment of the present invention. Referring to FIG. 2, the jet nozzle 100 is placed on a length-direction central axis, a supply path 230 is formed in the jet nozzle 100 to correspond to the central axis 220, and the nozzle aperture 105 through which fluid is injected to the outside is formed on the end of the supply path 230. The jet nozzle 100 has a slanted surface 240 in which an outer diameter of the jet nozzle 100 gradually decreases in a forward direction of a front predetermined section and the jet nozzle 100 has a generally pointed structure.

Moreover, in the section where the slanted surface 240 is formed, a concave notch 200 is formed in the jet nozzle 100 to correspond to the nozzle aperture 105. More specifically, in the exemplary embodiment of the present invention, the concave notch 200 is formed by an outer notch surface 10.

In more detail, a virtual first vertical line 260 that crosses vertically to the central axis 220 is formed on a front end 270 of the jet nozzle 100. In addition, the outer notch surface 210 includes the first vertical line 260 and has a first acute angle 250 to the central axis 220. Herein, the outer notch surface 210 is formed at both sides based on a first plane 290 including the first vertical line 260 and the central axis 220.

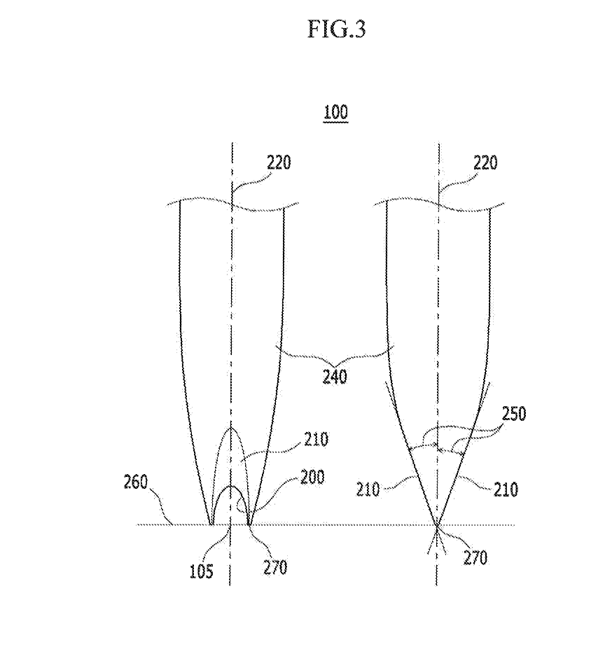

FIG. 3 is first and second side views of a jet nozzle according to the first exemplary embodiment of the present invention. Referring to a left side view (first side view) of FIG. 3, the concave notch 200 formed by the outer notch surface 210 and an inner circumference of the supply path 230 of the jet nozzle 100 has an “n” shape. Referring to a right side view (second side view) of FIG. 3, the outer notch surface 210 is formed at both sides based on the central axis 220 to form a “V”-shaped outer surface, In the exemplary embodiment of the present invention, the outer notch surface 210 may be integrally formed when the jet nozzle 100 is formed or may be formed through separate grinding.

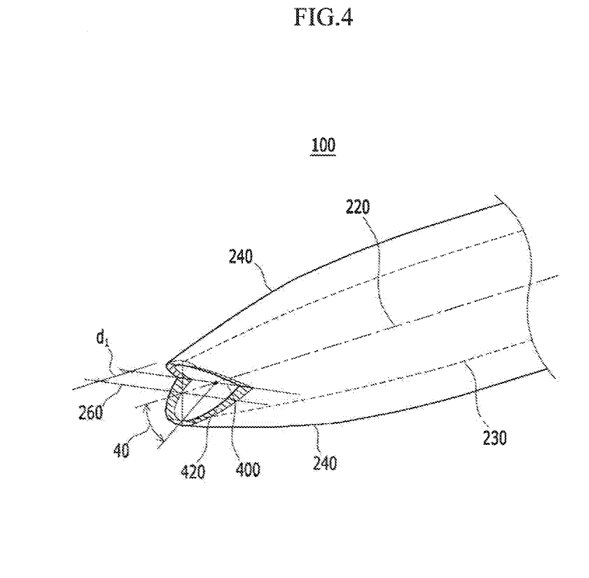

FIG. 4 is a partial perspective view of a jet nozzle provided in a jet pump unit according to a second exemplary embodiment of the present invention. Referring to FIG. 4, the jet nozzle 100 is placed on the length-direction central axis 220, the supply path 230 is formed in the jet nozzle 100 to correspond to the central axis 220, and the nozzle aperture 105 through which fluid is injected to the outside is formed on the end of the supply path 230. The jet nozzle 100 has a slanted surface 240 in which an outer diameter of the jet nozzle 100 gradually decreases in a front direction of a front predetermined section and the jet nozzle 100 has a forward pointed structure.

Moreover, in the section where the slanted surface 240 of the jet nozzle 100 is formed, the concave notch 200 is formed in the jet nozzle 100 to correspond to the nozzle aperture 105. In the exemplary embodiment of the present invention, the concave notch 200 is formed by an inner notch surface 420.

In more detail, the virtual first vertical line 260 that crosses vertically to the central axis 220 is formed on the end of the jet nozzle 100, and a virtual second vertical line 400 is formed, which is spaced from the first vertical line 260 by a first distance d1 which is set rearward, crosses vertically to the central axis 220, and is parallel to the first vertical line.

In addition, the concave notch 200 includes the second vertical line 400 and is formed by the inner notch surface 420 which has a second acute angle 40 to the central axis 220. Herein, the inner notch surface 420 is formed at both sides based on the first plane 290 including the second vertical line 400 and the central axis 220.

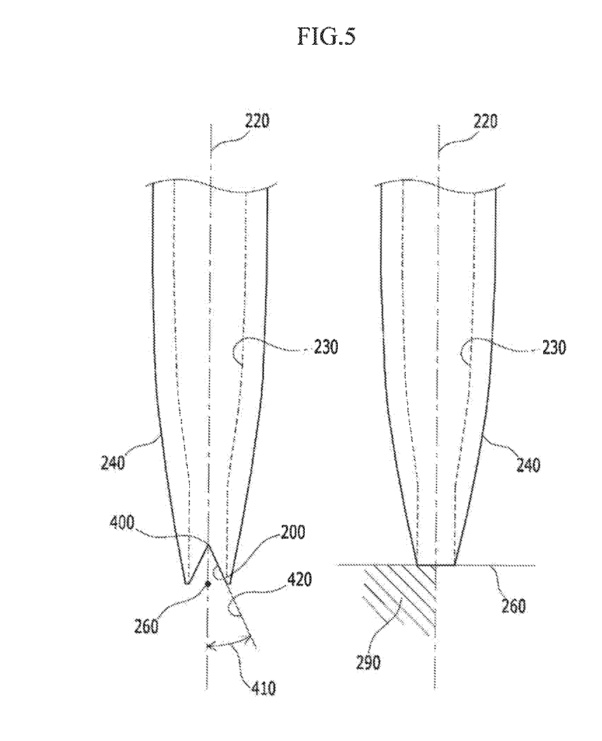

FIG. 5 is first and second side views of the jet nozzle according to the second exemplary embodiment of the present invention. Referring to a left side view (first side view) of FIG. 5, the concave notch 200 formed by the inner notch surface 420 and the inner circumference of the supply path 230 of the jet nozzle 100 has a “̂” shape. Referring to a right side view (second side view) of FIG. 5, the front end 270 of the jet nozzle 100 is parallel to the central axis 220 except for the concave notch 200. In the exemplary embodiment of the present invention, the inner notch surface 420 may be integrally formed when the jet nozzle 100 is formed or may be formed through separate grinding.

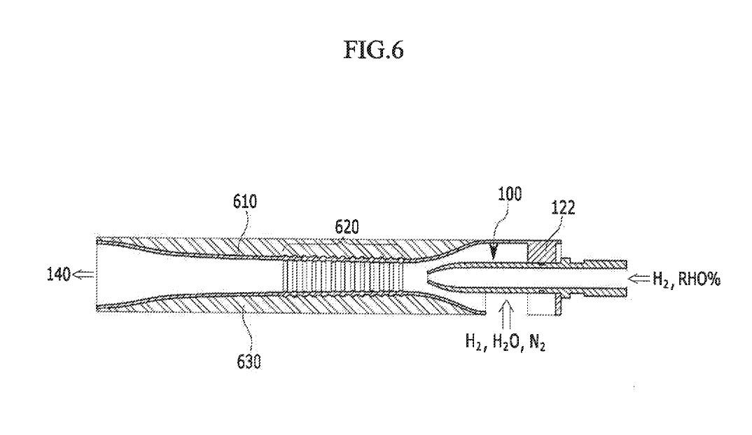

FIG. 6 is an overall cross-sectional view of a jet pump unit according to a third exemplary embodiment of the present invention. Referring to FIG. 6, the jet pump unit includes a nozzle housing 122, a jet nozzle 100, and a mixture pipe 110.

The vacuum chamber 120 that sucks fluid including hydrogen, nitrogen, and water discharged from the fuel cell from the bottom is formed in the nozzle housing 122 and a front part of the jet nozzle 100 is inserted into the nozzle housing 122. In addition, the nozzle aperture 105 injecting hydrogen is formed on the front end of the jet nozzle 100.

The mixture pipe 110 is placed at a front portion of the jet nozzle 100 and the mixture pipe 110 has a structure in which the hydrogen fluid injected from jet nozzle 100 and the fluid that is sucked into the nozzle housing 122 are mixed. A wrinkle pipe 620 is integrally formed at an intermediate portion of the mixture pipe 110 as well. The turbulence caused by the wrinkle pipe 620 promotes mixing of the recirculation fluid discharged from the fuel cell and the hydrogen injected form the jet nozzle 100. Additionally, a momentum of the hydrogen injected during such a mixing process is effectively transferred to fluid and flowing in a mixture part becomes generally more uniform. In particular, it is effective to apply the wrinkle pipe 620 to the mixture part of the mixture pipe 110 in which the inner diameter of the pipe is smallest and a flow velocity is highest in the recirculation line. It is also possible to apply a metallic wrinkle pipe or a plastic-made wrinkle pipe.

In the exemplary embodiment of the present invention, a shielding member 630 is formed on an exterior of the mixture pipe 110. The shielding member 630 may be formed on the outer circumference of the mixture pipe 110 with a set thickness and reduces noise generated from the inside of the mixture pipe 110. Herein, the shielding member 630 may reduce noise and achieve an insulation effect. As such, an insulation material or a sound absorption material may be used as the shielding member.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100: Jet nozzle | 105: Nozzle aperture |
| 110: Mixture pipe | 112: Mixture space |
| 120: Vacuum chamber | 122: Nozzle housing |
| 130: Recirculation line | 140: Fuel cell |
| 200: Concave notch | 210: Outer notch surface |
| 220: Central axis | 230: Supply path |
| 240: Slanted surface | 250: First acute angle |
| 40: Second acute angle | 260: First vertical line |
| 270: Front end | 290: First plane |
| 400: Second vertical line | 420: Inner notch surface |
| 620: Wrinkle pipe | 630: Shielding member |

What is claimed is:

1. A jet pump unit, comprising:
a nozzle housing having a vacuum chamber formed therein and connected with a recirculation line;
a jet nozzle in which a front end is placed in the vacuum chamber of the nozzle housing, a nozzle aperture injecting fluid to the outside is formed on the front end, a slanted surface is formed on an exterior with an outer diameter gradually decreasing toward the nozzle aperture, and a concave notch is concave toward a rear end of the nozzle aperture; and
a mixture pipe in which the fluid injected from the nozzle aperture of the jet nozzle and recirculation fluid that is sucked into the vacuum chamber are mixed.

2. The jet pump unit of claim 1, further comprising:
a virtual first vertical line crossing vertically to the central axis on the front end of the nozzle aperture of the jet nozzle, and
wherein the concave notch is formed by an outer notch surface including the first vertical line and having a first acute angle to the central axis.

3. The jet pump unit of claim 2, wherein:
the outer notch surface is symmetrically formed at both sides based on the central axis of the jet nozzle.

4. The jet pump unit of claim 2, wherein:
a virtual second vertical line is formed, which is parallel to the virtual first vertical line that crosses vertically to the central axis on the front end of the nozzle aperture of the jet nozzle, and
which is spaced from the first vertical line by a first distance which is set in a rearward direction, crosses vertically to the central axis, and is parallel to the first vertical line, and
the concave notch is formed by the inner notch surface including the second vertical line and having a second acute angle to the central axis.

5. The jet pump unit of claim 4, wherein:
the inner notch surface is symmetrically formed at both sides based on the central axis of the jet nozzle.

6. The jet pump unit or claim 1, wherein:
an intermediate portion having an inner diameter that is smaller than the other portions of the mixture pipe is formed by a wrinkle pipe.

7. The jet pump unit of claim 6, wherein:
a shielding member is placed on an exterior of the mixture pipe.

8. The jet pump unit of claim 7, wherein:
the shielding member includes a sound absorption material or an insulation material.

9. The jet pump unit of claim 1, wherein:
a supply path connected with the injection aperture and having an inner diameter set on a length-direction central axis is formed in the jet nozzle.

10. The jet pump unit of claim 9, wherein:
the set inner diameter gradually decreases toward the nozzle aperture of the jet nozzle.
